(19) United States
(12) Patent Application Publication
(10) Pub. No.: US 2012/0127732 A1
(43) Pub. Date: May 24, 2012

(54) REFLECTIVE LAMPSHADE THAT IS ENVIRONMENT-FRIENDLY AND ENERGY-SAVING

(75) Inventor: Hongyan WANG, Xiamen (CN)

(73) Assignee: Xiamen Xing HengLong Lighting Technology Co. Ltd., Fujian (CN)

(21) Appl. No.: 13/299,526

(22) Filed: Nov. 18, 2011

(30) Foreign Application Priority Data
Nov. 19, 2010 (CN) 201020615415.7

(51) Int. Cl. F21V 7/00

(52) U.S. Cl. 362/341

(57) ABSTRACT

A reflective lampshade that is has a main body in which the cavity of the lampshade is reflective, wherein said cavity diffuse axially from the end that is close to the light source to the end that is far from the light source. The inside surface of the cavity is smeared with nano coat. The nano coat on the inside surface of the cavity has high reflectivity for visible light and infrared light, and reflect the light and heat produced by the light source to the outside of the lampshade. The nano coat is heat and fade resistant. In addition, the nano coat reduces the accumulation of dust or vapors.

### FIELD OF THE INVENTION

The present invention relates to a reflective lampshade that is environment-friendly and energy-saving.

### BACKGROUND OF THE INVENTION

The lampshade is used to converge the light transmitted from the light source so that the utilization rate of the light source can be raised, and it can be energy-saving. At present, the shape of lampshade is cylinder or cone frustum. On the process of light converging, the heat produced by the light source is concentrated on the inside of the lampshade and make the temperature of the light source raised so that the stabilization of the command system of electric circuit and the working life of the light source and the lampshade are influenced.

### SUMMARY OF THE INVENTION

The object of the present invention is to offer a reflective lampshade that is environment-friendly and energy-saving to make the technical problem mentioned above solved. It includes the main body of the lampshade in which a cavity is formed, wherein said cavity diffuse axially from the end that is close to the light source to the end that is far from the light source. The inside surface of the cavity is reflective and smeared with nano coat.

As one of the preferred embodiments of the present invention, the said cavity is divided into a number of reflecting regions which are like the scarfskin of pineapple.

As one of the preferred embodiments of the present invention, the thickness of the said nano coat is 0.08-0.25 mm.

As one of the preferred embodiments of the present invention, a mounting hole is located in the upper end of the said main body of the lampshade. The said mounting hole is in the center of the main body axially.

As one of the preferred embodiments of the present invention, the shape of the said cavity is cone frustum.

As one of the preferred embodiments of the present invention, the shape of the said cavity is trumpet.

The beneficial effects from the technical scheme are:

(1) The nano coat on the inside surface of the cavity has high reflectivity for visible light and infrared light, and reflect the light and heat produced by the light source to the outside of the lampshade. In addition, the nano coat can prolong the working life of the lampshade by preventing the accumulation of dust and vapors.

(2) The shape of the cavity of the lampshade is made to diffuse axially from the end that is close to the light source to the end that is far from the light source according to the principle of optical reflection, such as trumpet or cone frustum, and it can improve the reflection effect and enhance the efficacy of the lamp by more than 30%-35%.

(3) The cavity divided into a number of reflecting regions which are like the scarfskin of pineapple optimizes the reflection effect and enhance the lighting effect of the whole lamp by more than 70%-80%.

(4) the 360° irradiation of the vertical lamp source decreases the light lost by 30% and energy cost by 70%-80% to achieve the indicator of environment-friendly.

### BRIEF DESCRIPTION OF THE DRAWINGS

FIG. 1 shows a vertical view of the reflective lampshade that is environment-friendly and energy-saving according to the present invention.

FIG. 2 shows a front view of the 1^{st} embodiment of the reflective lampshade that is environment-friendly and energy-saving according to the present invention.

FIG. 3 shows a front view of the 2^{nd} embodiment of the reflective lampshade that is environment-friendly and energy-saving according to the present invention.

### DESCRIPTION OF THE PREFERRED EMBODIMENTS

With the following description of the drawings and specific embodiments, the invention shall be further described in details.

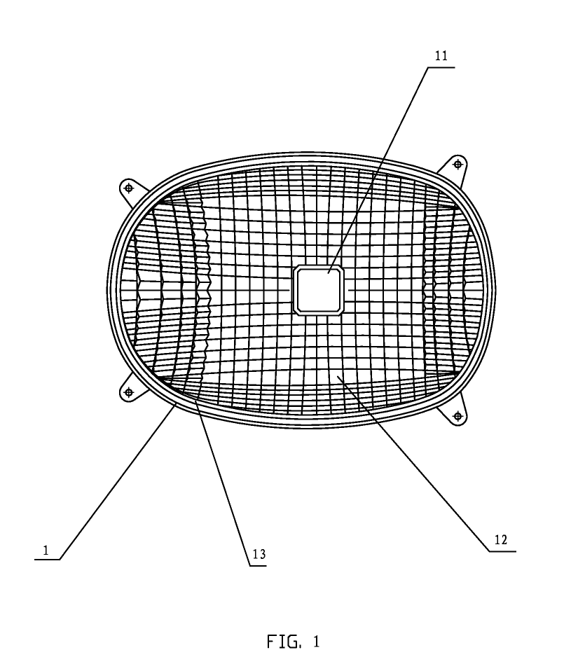

In FIG. 1, a reflective lampshade that is environment-friendly and energy-saving according to the present invention includes the main body 1 of the lampshade in which a cavity 12 is formed, wherein said cavity 12 diffuse axially from the end that is close to the light source to the end that is far from the light source (not shown in this figure). The inside surface of the cavity 12 is reflective and smeared with nano coat 13 which can be plated to the cavity 12 of the main body 1 by sputtering. The nano coat 12 has high reflectance of light and heat, which can reflect the light and heat to the outside of the main body 1 in development. In a preferred embodiment, the thickness of the nano coat 13 is 0.08-0.25 mm. In addition, the nano coat 13 can make the cavity 12 of the main body 1 not easy to accumulate dust or vapors. A mounting hole 11 is located in the center of the main body 1 axially. The lamp source is mounted in the main body 1 vertically so that the light transmitted by the lamp source can spread evenly on the inside of the main body 1. As a preferred embodiment, the cavity 12 is divided into a number of reflecting regions which are like the scarfskin of pineapple, and it makes the reflection of light or heat easier to the outside of the inner cavity which belongs to the main body 1.

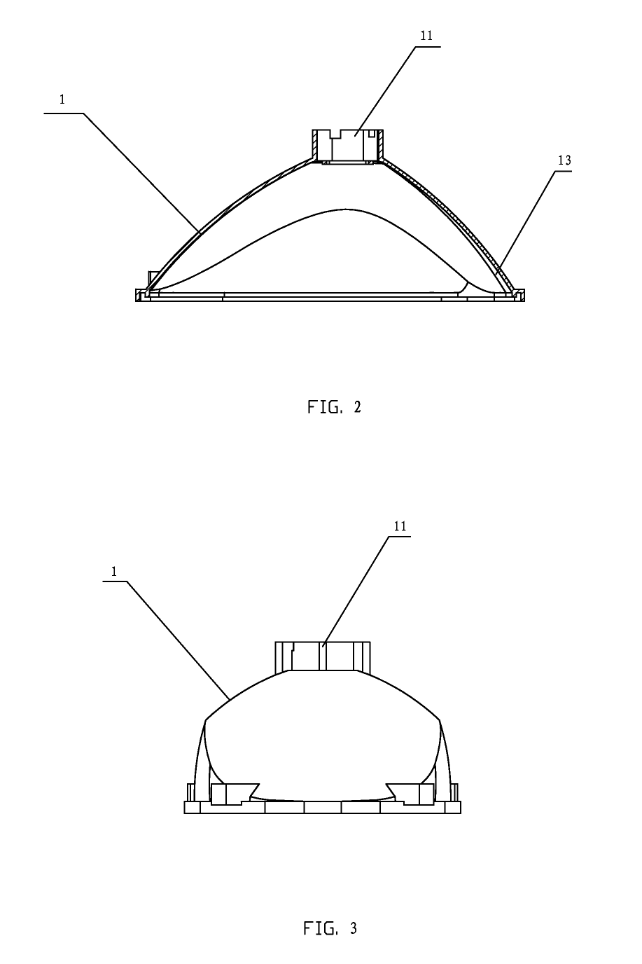

FIG. 2 and FIG. 3 show two kinds of embodiments of the main body 1. In the 1^{st} embodiment, the shape of the cavity 12 is cone frustum, the mounting hole 11 is located in the center of the main body 1 axially, and the nano coat 13 is on the inside surface of the cavity 12. The difference between the 1^{st} and the 2^{nd} embodiment is that the shape of the cavity 12 is trumpet in the 2^{nd} embodiment. The present invention can use any kind of shape which accords to the principal of optical reflection with blazonry without any limitation.

The invention has been described with reference to the preferred embodiments mentioned above; therefore it cannot limit the reference implementation of the invention. It is obvious to a person skilled in the art that structural modification and changes can be carried out without leaving the scope of the claims hereinafter and the description above.

What is claimed is:

1. A reflective lampshade that is environment-friendly and energy-saving includes the main body of the lampshade in which a cavity of which the inside surface is reflective is formed, wherein said cavity diffuse axially from the end that is close to the light source to the end that is far from the light source; the inside surface of the cavity is smeared with nano coat.

2. The reflective lampshade that is environment-friendly and energy-saving according to claim 1, wherein said cavity is divided into a number of reflecting regions which are like the scarfskin of pineapple.

3. The reflective lampshade that is environment-friendly and energy-saving according to claim 1, wherein the thickness of the said nano coat is 0.08-0.25 mm.

4. The reflective lampshade that is environment-friendly and energy-saving according to claim 1, wherein a mounting hole is located in the upper end of the said main body of the lampshade, which is in the center of the main body axially.

5. The reflective lampshade that is environment-friendly and energy-saving according to claim 1, wherein the shape of the said cavity is cone frustum.

6. The reflective lampshade that is environment-friendly and energy-saving according to claim 1, wherein the shape of the said cavity is trumpet.
